(19) United States
(12) Patent Application Publication
(10) Pub. No.: US 2023/0298089 A1
(43) Pub. Date: Sep. 21, 2023

(54) FACILITATING PURCHASING FROM WITHIN STREAMING VIDEOS

(71) Applicants: BUY Z, LLC, Clearwater, FL (US); TIGHT WORK ENTERPRISES, LLC, Clearwater, FL (US)

(72) Inventors: JOHN PETERSON, CLEARWATER, FL (US); MAXX MILLER, Clearwater, FL (US)

(73) Assignees: BUY Z, LLC, CLEARWATER, FL (US); TIGHT WORK ENTERPRISES, LLC, CLEARWATER, FL (US)

(21) Appl. No.: 17/844,256

(22) Filed: Jun. 20, 2022

Related U.S. Application Data
(60) Provisional application No. 63/320,352, filed on Mar. 16, 2022.

(51) Int. Cl. G06Q 30/06; H04N 21/478

(52) U.S. Cl. CPC G06Q 30/0641; H04N 21/47815

(57) ABSTRACT

The present inventive solution relates to facilitating purchasing of products and services that appear in video content, for increasing conversion rates to sales. A video player accesses a video and timestamped metadata relating to the content of the video. A Graphical User Interaction module uses them to create a purchase facilitator, which is rendered by a video renderer onto the video content. A purchase manager receives the purchase facilitator and a user's purchase command, and services the purchase command, which is associated with the purchase facilitator, by contacting an e-commerce platform. The GUI module receives from the e-commerce platform and feeds to the video renderer a description, a price, and payment instructions for the product associated with the purchase command. In another exemplary embodiment, the purchase manager creates a set of purchase commands equal to the number of products contained in the video.

### BACKGROUND

### Field

The present invention relates to facilitating purchasing of products and services that appear in streaming video content, for increasing conversion rates to sales.

### Background Information

On-line purchasing and e-commerce have seen a widespread use during the last two decades, initially for Business-to-Business (B2B) sales and later for any type of sale. The current pandemic has further increased on-line sales by a huge amount as a convenient means for purchasing products and services, anytime and from everyplace. This trend has been enhanced by the wide availability of reliable broadband communications and handy computing devices, like smartphones and tablets, that consumers are routinely using.

The desire to buy a product and the process of initiating a sale starts long before the actual sale taking place and always involves a step where the potential buyer's attention and desire to a product is caught and created, respectively, by various channels and means. Involuntarily is one means, where the potential buyer sees, or hears about, or even tests a product before he decides to buy it. This process is regularly enhanced by marketers with advertisements, free samples and other means for attracting attention to a product and for creating a desire to buy the product.

Consumers do not react the same to different products, or to different marketing tools. Attention catching and building desire to buy products can be very difficult, time consuming, and expensive and more often than not involve low conversion rates leading to sales.

Marketing uses every available channel and means to reach prospective customers and covert them to buyers of products and services. Billboards, newspapers, radio, TV, and many other traditional channels have been supplemented and to a large degree replaced by advertisements in on-line media, like websites, social media, and streaming video sources. This transition to on-line media has to do with their deep penetration to the habits and everyday life of consumers, i.e. the entire population, and the fact that many consumers, especially younger ones, have replaced traditional media with on-line channels.

In recent years video streaming is widely used for delivering video content to viewers and presenting them with advertisements in an effort to sell products in a more efficient way. However, despite the various marketing tools that are employed, advertisements in on-line media, and streaming video in particular, result in rather low conversion rates and sales despite any gains they may achieve over traditional media. These gains may be attributed largely to the presentation of a personalized selection of advertisements matching the viewer's profile and/or interaction.

However, despite providing information on products and services on sale, advertisements in on-line media, and in streaming video in particular, fail to increase conversion rates because viewers either ignore them as they are drowned with advertisements in every minute of their daily lives, or because they find ways to suppress or skip the advertisements, or simply because they are cautious and do not believe the marketing messages conveyed by the advertisements.

There is, therefore, a need to further increase viewer conversions rates into sales. This need is applicable to streaming video but may also apply to other online media.

### SUMMARY

The present disclosure is directed to a system, device, apparatus, methodology, and software for facilitating purchase of products and services that appear in the content of streaming video.

The system consists of a computing device, like a smart TeleVision (TV), desktop computer, laptop, or mobile device used for playing streaming video, an interaction device, like a portable computing device or remote control, and an e-commerce platform, all linked to the computing device for playing streaming video via a data link, like a network or a direct link. At a lower level, the system is made up of a streaming video player, an interaction module, a video renderer, a purchase manager and the e-commerce platform. In one aspect, the e-commerce platform is not part of the present system but an external platform to which the purchase manager of the system connects.

In variations of this exemplary embodiment, the system also has one or more microphone and speaker to provided alternative interaction means.

In a first embodiment, the video player accesses and decodes/decompresses streaming video from a, typically external to the system, source like a streaming video server, or similar source, and also accesses timestamped metadata relating to the content of the streaming video (e.g. products depicted in the streaming video content). The resulting decoded/decompressed video and the metadata are fed to the Graphical User Interaction (GUI) module which uses them to create a purchase facilitator, which is associated with timestamped metadata and the product that appears in the present scene of the streaming video content. The video renderer receives the video content (from the video player, or from the GUI) and the purchase facilitator (from the GUI) and creates an augmented video by rendering the purchase facilitator onto the video content. The augmented video is displayed at the computing device, and in alternative implementations also to other devices.

The purchase manager receives the purchase facilitator from the GUI, and a user purchase command from the GUI once the user enters such a command, and services the purchase command using the purchase facilitator by contacting the e-commerce platform with the purchase command, which command is associated with the purchase facilitator. The GUI receives from the e-commerce platform, via the purchase manager, and feeds to the video renderer a description and a price of the product associated with the purchase command.

In a second exemplary embodiment, the purchase manager creates a set of purchase commands equal to the number of products contained in the streaming video segment that the viewer has viewed since the current streaming video playing session was launched. Purchase manager sends the set of purchase commands to the e-commerce platform, which replies with a set of product descriptions, prices and payment instructions. These are then rendered in the video content to create an augmented video with description, price and payment instructions for the products associated with the set of purchase commands. These may be presented to the user in a list (or other similar structure) format onto the video content for him to choose.

In a third alternative implementation, the augmented video (prior to the user entering his purchase command) contains the video content embedded with a set of purchase facilitators associated with a set of the number of products contained in the current and the streaming video segment that the viewer has viewed since the current streaming video playing session was launched, e.g. presented in a list (or other similar structure) format. The viewer then selects a purchase facilitator and enters a purchase request associated with the selected purchase facilitator, which is serviced by the purchase manager.

In a fourth exemplary embodiments, the purchase facilitator may optionally have a time duration for rendering in the video content for displaying in the augmented video, of for purchasing the product (i.e. for being serviced by purchase manager).

In a fifth exemplary implementation, when the purchase facilitator is selected by the viewer, the video is paused. The video is resumed when the user completes or aborts his purchase.

In a sixth exemplary implementation, a mechanism using tags associated with products contained the video content enables the purchase facilitator to be linked with an e-commerce site, thereby allowing the viewer to easily navigate the e-commerce site. The site also uses the tags to implement marketing campaigns, offer discounts, etc.

In a seventh exemplary implementation, a mechanism is used for relating the terms of purchase, discounts, etc., once the viewer has entered the e-commerce site, to the duration of the streaming video. This data is linked to the system which may set a discount price valid only until the end of the live game or until the end of the current part of the live game.

In an eighth exemplary implementation, a mechanism is used to Activate/Deactivate the purchase facilitator while ensuring that the button will, upon activation, will present a list of products that currently or previously appeared in the video without missing any products that were screened while the purchase facilitator was deactivated.

In a ninth exemplary implementation, an interaction mechanism using the same device used for screening the video, and/or another device used for interaction is used.

In a tenth exemplary implementation, the purchase facilitator is used in any type of video or TV content, including broadcast video, movies, commercials, etc.

In all exemplary embodiments products may be services, or a combination of products and services.

### BRIEF DESCRIPTION OF THE DRAWINGS

FIG. 1 shows a system for promoting purchasing of products in a streaming video according to the prior art.

FIG. 2 shows a system for facilitating purchasing of items displayed in a streaming video.

FIG. 3 shows a mid-level view of the main modules of the present innovative solution, and their interactions.

FIG. 4 shows an example streaming video with a rendered advertisement according to the prior art.

FIG. 5 shows an example streaming video with a purchase facilitator according to a first exemplary embodiment of the present innovative solution.

FIG. 6 shows an example streaming video with a purchase facilitator according to a second exemplary embodiment of the present innovative solution.

FIG. 7 shows a mid-level view of the main modules of the present innovative solution, and their interactions for the 5^{th} exemplary implementation.

FIG. 8 shows a mid-level view of the main modules of the present innovative solution, and their interactions for the 6^{th} exemplary implementation.

FIG. 9 shows a mid-level view of the main modules of the present innovative solution, and their interactions for the 8^{th} exemplary implementation.

FIG. 10 shows an example streaming video with a purchase facilitator according to the 5^{th} exemplary embodiment of the present innovative solution.

FIG. 11 shows an example streaming video with a purchase facilitator according to the 6^{th} exemplary embodiment of the present innovative solution.

FIG. 12 shows an example streaming video with a purchase facilitator according to the 8^{th} exemplary embodiment of the present innovative solution.

### DETAILED DESCRIPTION

The word “exemplary” is used herein to mean “serving as an example, instance, or illustration”. Any embodiment described herein as “exemplary” is not necessarily to be construed as preferred or advantageous over other embodiments.

The terms “user device”, “mobile device” and “source device” are used interchangeably and have the same meaning.

The terms “viewer”, “user”, and “client” are used interchangeably and have the same meaning.

The terms “product” and “service” are used interchangeably and have the same validity and applicability in the discussion below.

Terms not specifically defined herein have their art recognized meaning.

As used herein and in the appended claims, the singular forms “a” and “the” include plural referents unless the context clearly dictates otherwise.

The acronym “B2B” is intended to mean “Business-to-Business”.

The acronym “CD” is intended to mean “Compact Disc”.

The acronym “CD-ROM” is intended to mean “Compact Disc Read Only Memory”.

The acronym “DSL” is intended to mean “Digital Subscriber Line”.

The acronym “DVD” is intended to mean “Digital Versatile Disc”.

The acronym “EEPROM” is intended to mean “Electrically Erasable Programmable Read Only Memory”.

The acronym “GUI” is intended to mean “Graphical User Interface”.

The acronym “IP” is intended to mean “Internet Protocol” and can refer to either IPv4 or IPv6.

The acronym “IR” is intended to mean “InfraRed”.

The acronym “Net” is intended to mean “Network”.

The acronym “OS” is intended to mean “Operating Systems”.

The acronym “QR” is intended to mean “Quick Response”.

The acronym “RF” is intended to mean “Radio Frequency”.

The acronym “RAM” is intended to mean “Random Access Memory”.

The acronym “ROM” is intended to mean “Read Only Memory”.

The acronym “TV” is intended to mean “TeleVision”.

The acronym “TXT” is intended to mean “TeXT”.

The acronym “URL” is intended to mean “Universal Resource Locator”.

The acronym “XML” is intended to mean “eXtensible Markup Language”.

The present disclosure describes a system, device, apparatus, techniques, and software for facilitating purchasing products and/or services displayed in a streaming videos.

### PRIOR ART

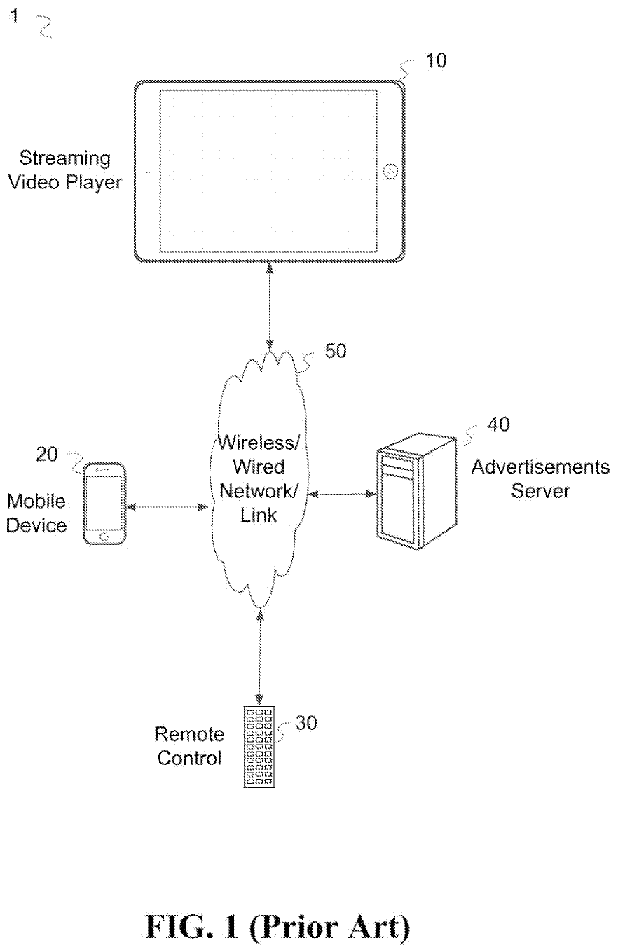

FIG. 1 shows a system for promoting purchasing of products in a streaming video according to the prior art. System 1 is made of a smart television (TV) or computing device (e.g. a desktop computer, a laptop, a tablet, or a smartphone) 10 for playing streaming video, a mobile device 20 (e.g. a smartphone, or a tablet), a remote control 30, and an advertisement server 40, all connected to the streaming video player device 10 via a wired or wireless link (e.g. a public or private data network, a Radio Frequency (RF), or InfraRed (IR), or sound link).

Streaming video player device 10 receives streaming video from a server external to system 1 (not shown in FIG. 1) and displays it at a screen integrated or connected to device 10 (not shown). Device 10 also receives advertising content (e.g. graphics or video) from advertisement server 40, which it interlaces in the streaming video (e.g. by interrupting the video and replacing in with the advertisement video, and resuming the steaming video once the advertisement video has completed), or embeds in the streaming video (e.g. by presenting the advertisement video as a small window overlayed on top of a portion of the streaming video).

Such advertisement video is served from advertisement server 40 to the device 10 based on a schedule created by advertisement server 40, or more frequently by adapting this schedule based on viewer profile and/or interactions which are communicated by device 10 to advertisement server 40. The viewer can interact with video playing device 10 via remote control 30, or mobile device 20, or directly via an interface on device 10. In alternative exemplary embodiments, the viewer may use mobile device 20 for viewing the streaming video and for interaction.

The aim of such a system is to attract the viewer's attention and try to “lure” him to visit a web-site of an e-commerce platform, or a physical store, and persuade him to buy the advertised product, which is usually not contained in the streaming video content. In other words, prior art systems are attention grabbers and servicing methods for advertisements for any type of product advertisers want to promote, among others, through streaming video channels. So, the prior art solves the problem of how to catch the attention of potential buyers. The solution presented by the prior art is a way of serving advertisements in streaming videos so as to exploit an additional medium channel (i.e. the streaming videos).

The Innovative Solution—Basic Versions

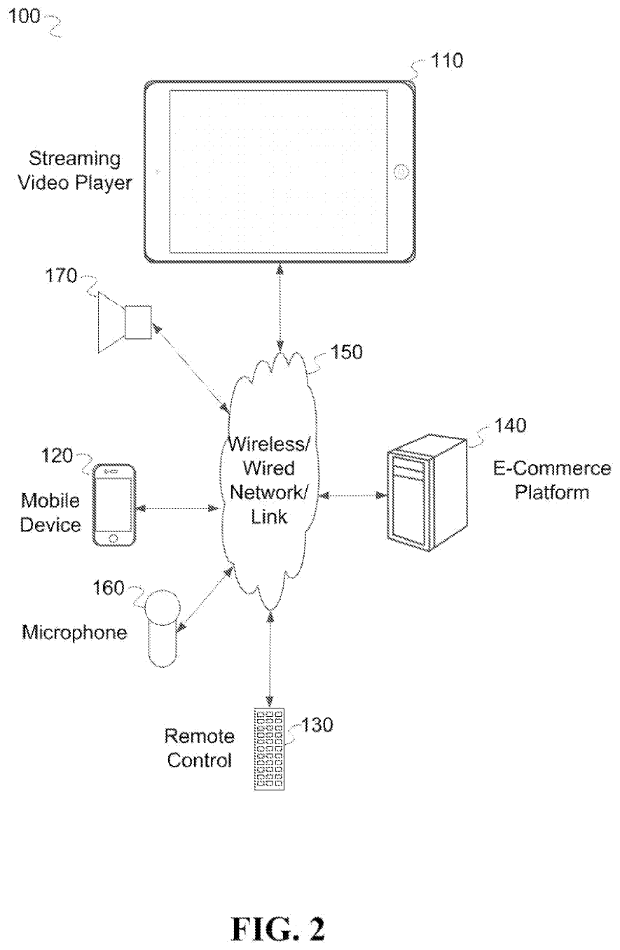

FIG. 2 shows a system for facilitating purchasing of items displayed in a streaming video. In contrast to the prior art, the present innovative solution deals with a totally different problem, of how to facilitate purchasing of products and services that are already contained in the content of the streaming video; not in an advertisement that is interlaced or embedded in the streaming video. The present innovative solution does not display any advertisements in the streaming video because there is no need to attract the viewer's attention to a product that is advertised although in other exemplary implementations advertisements may be interlaced or rendered in the streaming video by other systems not forming part of the present innovative solution. The user's attention is automatically attracted to a product shown in the streaming video, by means of the actual “story” told by the video content, which either already appealed to the interests of the viewers prior to viewing the streaming video content (so no need to advertise the product), or creates an appealing sensation while viewing the video content (again no need to advertise the product).

As a result, the present innovative solution has nothing to do with playing or managing advertisements inside a streaming video. Instead, it provides a mechanism for facilitating the purchasing of the products that appear in the content of streaming videos. In other words, after the streaming video content has attracted the pre-existing interest of the viewer for a product, or of the new interest for this product created by viewing the video content, the present innovative solution provides a novel and unexpected way to facilitate the buying of the product, effectively maximizing potential customer conversion rates to sales.

System 100 is used to facilitate the buying of products that appear in the content of streaming videos. It is made of a smart TeleVision (TV) or computing device (e.g. a desktop computer, a laptop, a tablet, or a smartphone, etc.) 110 for playing streaming video, a mobile device 120 (e.g. a smartphone, or a tablet), a remote control 130, and an e-commerce platform 140, all connected to the streaming video player device 110 via a wired or wireless link (e.g. a public or private data network, a Radio Frequency (RF), or InfraRed (IR), or sound link).

Streaming video player 110 receives streaming video from a server external to system 1 (not shown in FIG. 1) and displays it at a screen integrated or connected to device 110 (not shown). Device 110 also communicates with e-commerce platform 140, for facilitating the buying of products that are shown in the streaming video content.

Streaming video player device 110 may optionally interlace or embed advertisements in the streaming video. This feature is not a part of the present innovative solution but may be used for compatibility with existing streaming video systems.

The viewer can interact with video playing device 110 via remote control 130, or mobile device 120, or directly via an interface on device 110. In alternative exemplary embodiments, the viewer may use mobile device 120 for viewing the streaming video and for interaction.

1st Exemplary Implementation

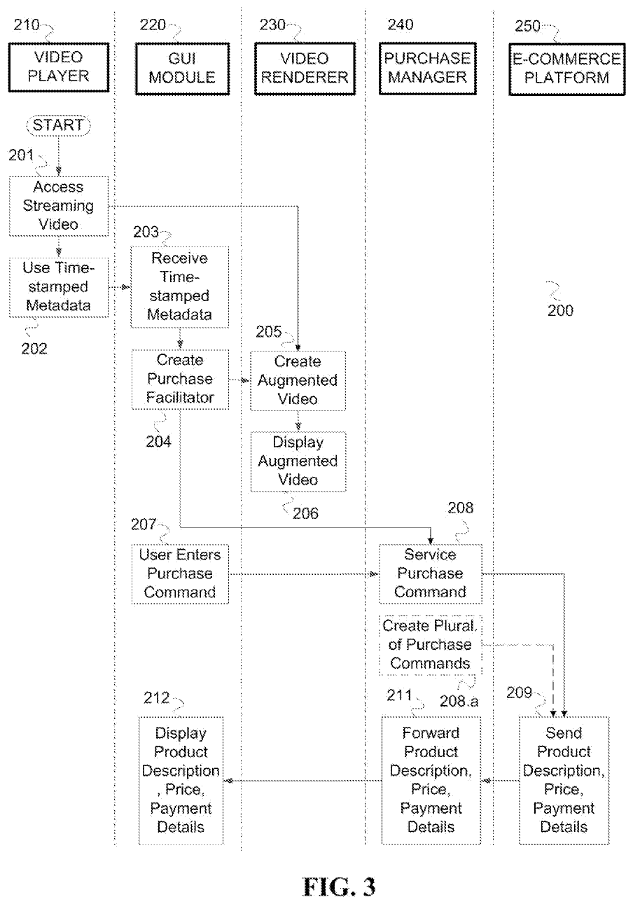

FIG. 3 shows a mid-level view of the main modules of the present innovative solution, and their interactions. View 200 shows the modules of Streaming Video Player 210, Graphical User Interface (GUI) 220, Video Renderer 230, Purchase Manager 240, and e-Commerce Platform 250. These modules may be implemented in hardware, software, firmware, or a combination thereof. In one aspect, modules 210-240 are implemented in streaming video player device 110, while in another aspect they are implemented in device 120 and/or 110.

E-commerce platform module 250 is implemented in e-commerce platform 140, which may reside in one or more e-commerce servers, or in the cloud. In alternative exemplary embodiments, the e-commerce platform 140 and module 250 are third-party e-commerce platforms (usually over the cloud) to which purchase manager 240 connects via connection/network 150.

Video player 210 accesses 201 a streaming video from a streaming server (not shown), and uses timestamped metadata 202 associated with specific time-segments of the streaming video content. Such metadata may, among other data, contain keywords or descriptions associated with a product shown in the video content and for which the present innovative solution implements and offers to the viewer a purchase facilitator for the viewer to buy the product, which product has appealed to the viewer and created an urge to buy it, without having to rely to an advertisement shown interlaced or embedded in the streaming video content.

Video player 210 sends the video content (which it has processed, e.g. for decompression, etc.) to video renderer 230, and the timestamped metadata to GUI 220. GUI 220 receives 203 the timestamped metadata, and creates 204 a purchase facilitator 204, which then sends to video renderer 230 and to purchase manager 240. In one aspect, the purchase facilitator is a barcode, a matrix code (e.g. a Quick Response (QR) code), or a sound code, while in other aspects it is a color code, watermark, video code, or sound code. In yet another aspect, the purchase facilitator is a graphical button (on device 110 and/or 120) associated with one of the previous codes and/or a web-address, and/or Internet Protocol (IP) address pointing to a location at e-commerce platform 140, associated with the product that appears in the content of the steaming video, a Universal Resource Locator (URL) pointing to an IP address. In another aspect, the purchase facilitator is a hardware button (e.g. a button on remote control 130, or a hardware button in device 120) associated with one of the previous codes and/or a web-address, and/or Internet Protocol (IP) address pointing to a location at e-commerce platform 140, associated with the product that appears in the content of the steaming video. In yet another aspect the purchase facilitator is a combination of the previous. GUI 220 sends the purchase facilitator to video renderer 230.

Video renderer 230 receives the video content from video player 210 and the purchase facilitator from GUI 220 and creates 205 and displays 206 an augmented video containing the video content embedded with the purchase facilitator. In one aspect, only the purchase facilitator is embedded on the video content, while in another aspect instructions and other optional information are also embedded.

In a variation of the 1^{st} exemplary implementation, system 100 also has a speaker 170 connected to the device playing the streaming video (i.e. device 110 or 120) for playing aloud the sound code and/or instruction and other optional information to the user for purchasing the product shown in the streaming video content, using the purchase facilitator. In the same exemplary implementation having speaker 170, system 100 also has a microphone 160 connected to the device used by the viewer for interacting with the video playing module (i.e. device 120, 130, or 170) via speech commands in addition or instead of interacting via any other known non-verbal interaction method (e.g. virtual or physical button press, gesture, etc.).

The viewer views the augmented video, during and immediately after the appearance of the product associated with the purchase facilitator in the video content and enters a verbal or non-verbal purchase command 207 using GUI 220. GUI 220 associates the purchase command with the purchase facilitator and sends the purchase command to purchase manager 240.

Purchase manager 240 receives the purchase facilitator and the purchase command from GUI 220 and services 208 the purchase command using the purchase facilitator to which it is associated, by communicating with e-commerce platform 250.

E-commerce platform 250, upon receiving the purchase command, sends 209 a product description, price and payment instructions to purchase manager 240, which forwards 211 the product description, price and payment instructions as timestamped metadata to GUI 220 for displaying 212 to the viewer using the same mechanism previously described for creating and displaying the augmented video (steps 205, 206).

2nd Exemplary Implementation

In another exemplary implementation, purchase manager 240 creates, in step 208, a set of purchase commands 208.a equal to the number of products contained in the streaming video segment that the viewer has viewed since the current streaming video playing session was launched. Purchase manager sends the set of purchase commands to e-commerce platform 250, which replies with a set of product description, price and payment instructions. These are then rendered in the video content to create an augmented video with description, price and payment instructions for the products associated with the set of purchase commands. These may be presented to the user in a list (or other similar structure) format for him to choose.

3^{rd} Exemplary Implementation

In yet another alternative implementation, the augmented video (prior to the user entering his purchase command) contains the video content embedded with a first set of purchase facilitators associated with a first set of products contained in current scene of the streaming video, and a second set of purchase facilitators associated with a second set of products contained in the streaming video's past scenes that the viewer has viewed since the current streaming video playing session was launched, e.g. presented in a list (or other similar structure) format. The viewer then selects a purchase facilitator and enters a purchase request associated with the selected purchase facilitator, which is serviced by purchase manager 240.

4th Exemplary Implementation

In all exemplary embodiments, the purchase facilitator may optionally have a time duration for rendering in the video content for display in the augmented video, and/or for purchasing the product (i.e. for being serviced by purchase manager 240).

In all exemplary embodiments products may be services, or a combination of products and services.

Example Streaming Video Use Cases for the Basic Versions of the Innovative Solution

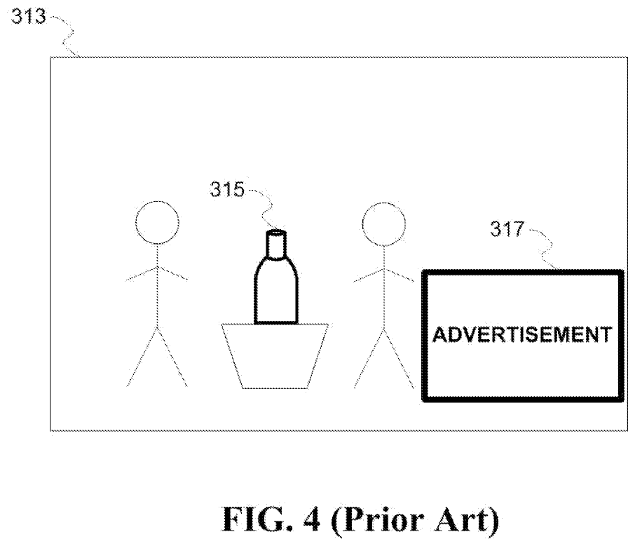

FIG. 4 shows an example streaming video with a rendered advertisement according to the prior art. Streaming Video 313 contains a scene where two persons are shown in front of a table which contains a bottle of whiskey 315. The video player displays a rendered advertisement 317. In one aspect, the advertisement is about a car (i.e. unrelated to the content of the scene of the streaming video) which is selected based on a viewer's profile or previous user interactions. In another aspect, the advertisement is about a brand of whiskey (i.e. related to the bottle of whiskey contained in the scene of the streaming video, regardless of brand), or of the same brand as the bottle of whiskey contained in the scene of the streaming video. Advertisement 317 is a means to seek the attraction of the viewer to the advertised product and for this reason may not always be of the same product as that depicted in the streaming video scene, or it may not be of the same packaging (e.g. the advertisement is directed to the same brand of whiskey but for a larger bottle, or for a more mature whiskey of the same brand). Advertisement 317 simply attracts the attention of the viewer towards the advertised product and does not provide any facilitator to purchasing the product. Even when a specific store or e-store is indicated in advertisement 317, the viewer is still not facilitated in buying the product, as he has to somehow figure out how to visit the store (i.e. find its address, opening times, and visit the store), or how to connect to the e-store (i.e. find the address of the e-store's home page, and then find the specific webpage within the e-store's site that contains the advertised product, and finally perform the e-purchase of the product advertised in the scene of the streaming video).

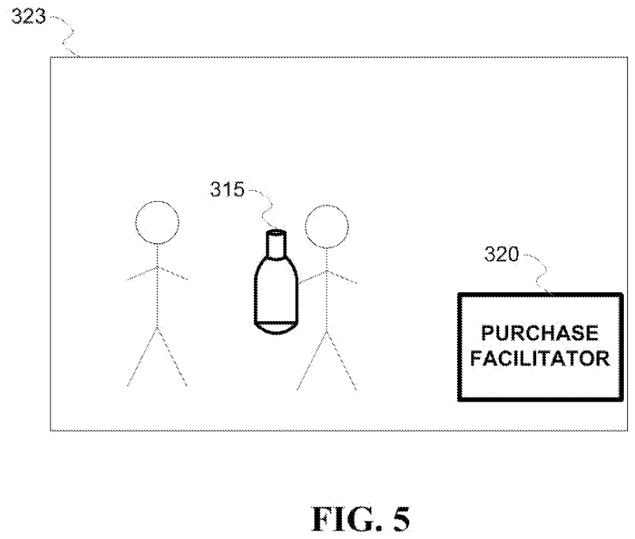

FIG. 5 shows an example streaming video with a purchase facilitator according to the first exemplary embodiment of the present innovative solution. Streaming Video 323 contains a scene where two persons are shown in front of a table which contains a bottle of whiskey 315. Video renderer 230 renders the content of the streaming video scene with a purchase facilitator 320, which is related to the bottle of whiskey 315 in the scene, and which purchase facilitator 320 facilitates the viewer to easily and quickly make his purchase according to the methodology presented in FIG. 3. Purchase facilitator 320 is not intended for attracting the viewer's attention to the product; attracting the viewer's attention is achieved by the product itself, i.e. the whiskey bottle that appears in the streaming video scene, and potentially also by the dialogues and the plot in the scene of the streaming video. Purchase facilitator 320 is merely a way to facilitate purchase of the product in the scene of the streaming video. As such, purchase facilitator 320 can guarantee a fast purchase (in some cases an impulsive purchase) for which the viewer has already developed a desire, or an intention to purchase. In the absence of purchase facilitator 320, the purchase of the product is complicated and time consuming and would require the viewer's full attention, which would require the viewer to stop viewing the streaming video and spoil his experience. This inconvenience is usually translated in a loss of sale either because the viewer has no intention to stop viewing the streaming video (e.g. especially in live streaming of sports events, or movies), and/or because the viewer postpones the purchase for after the end of the streaming session or during an intermission. However, postponing the purchase to a later time would result, in most situations, in a loss of a sale opportunity either because the viewer forgets about the product, and/or because he looses his interest in buying the said product (e.g. because his attention is drawn to another product, or because it may be too late to think about drinking spirits, or he has poured and drank vodka that he had at his house, or because he has managed to suppress his impulsive desire to buy the whiskey). So, the use of a purchase facilitator is extremely important in securing a sale of a product, and it is way more effecting than an advertisement of the same product because in contrast to the advertisement that seeks to attract the viewer's attention and then convert this attention to a sale, the purchase facilitator simply facilitates the viewer, whose attention is already drawn to the product by the product's appearance in the scene of the streaming video, and is very close to purchasing the product, and secures a sale.

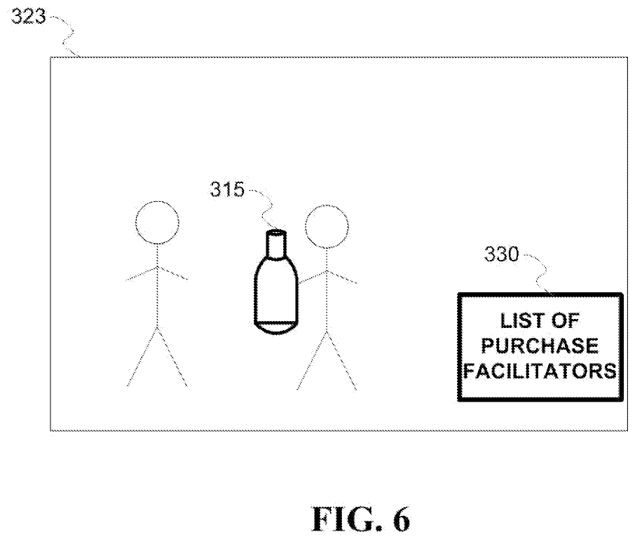

FIG. 6 shows an example streaming video with a purchase facilitator according to the second exemplary embodiment of the present innovative solution. Streaming Video 323 contains a scene where two persons are shown in front of a table which contains a bottle of whiskey 315. Video renderer 230 renders the content of the streaming video scene with a menu (or list or a similar structure) of purchase facilitators 330, which is related to the bottle of whiskey 315 in the scene, and which menu of purchase facilitators 330 facilitates the viewer to easily and quickly make his purchase according to the methodology presented in FIG. 3. Menu of purchase facilitators 330 is not intended for attracting the user's attention to the product; this is achieved by the product itself, i.e. the whiskey bottle that appears in the streaming video scene, and potentially also by the dialogues and the plot in the scene of the streaming video. Menu of purchase facilitators 330 is merely a way to facilitate purchase of the product in the scene of the streaming video. As such, menu of purchase facilitators 330 can guarantee a fast purchase (in some cases an impulsive purchase) for which the viewer has already developed a desire, or an intention, to purchase. In the absence of the menu of purchase facilitators 330, the purchase of the product is complicated and time consuming and would require the full viewer's attention, which would require the viewer to stop viewing the streaming video and spoil his experience. This inconvenience is usually translated in a loss of sale either because the viewer has no intention to stop viewing (e.g. especially in live streaming of sports events, or movies), and/or because the viewer postpones the purchase for after the end of the streaming session or during an intermission. However, postponing the purchase to a later time would result, in most situations, a loss of a sale opportunity either because the viewer forgets about the product, and/or because he loses his interest in buying the said product (e.g. because his attention is drawn to another product, or because it may be too late to think about drinking spirits, or he has poured and drank vodka that he had at his house, or because he has managed to suppress his impulsive desire to buy the whiskey). So, the use of a purchase facilitator is extremely important in securing a sale of a product, and it is way more effecting than an advertisement of the same product because in contrast to the advertisement that seeks to attract the viewer's attention and then convert this attention to a sale, the purchase facilitator simply facilitates the viewer, whose attention is already drawn to the product by the product's appearance in the scene of the streaming video, and is very close to purchasing the product, and secures a sale.

Menu of purchase facilitators 330 contains a list of purchase facilitators 320, where each purchase facilitator 320 in the menu is associated with a product shown in the streaming video. In one aspect, the purchase facilitator at the top of the list of purchase facilitators 330 is associated with a product that appears in the current scene of the streaming video. Purchase facilitators below the purchase facilitators at the top of the list of purchase facilitators 330 are associated with products that appeared in past scenes of the streaming video. The viewer can select the purchase facilitator at the top of the list of purchase facilitators 330 to purchase the product displayed in the current scene of the streaming video, or he can select one of the purchase facilitators below the purchase facilitators at the top of the list of purchase facilitators 330 for purchasing a product that appeared in past scenes of the streaming video, and which products have also attracted his attention. As a result, in addition to the benefits presented for the first exemplary embodiment of FIG. 5, the second exemplary embodiment also offers the benefit of converting to a sale the interest of a viewer for a product that appeared in past scenes of the streaming video, and which the viewer did not buy for any reason. So, the conversion rate to a product sale is further increased.

In another aspect of the second exemplary embodiment, a first set of purchase facilitators at the top of the list of purchase facilitators 330 is associated with more than one product that appears in the current scene of the streaming video. Purchase facilitators below the first set of purchase facilitators at the top of the list of purchase facilitators 330 are associated with products that appeared in past scenes of the streaming video. This way the viewer may select to purchase one or more of the more than one products that appear in the current scene of the streaming video and/or products that appeared in past scenes of the streaming video. The result of this functionality is a further increase in the conversion rate to a product sale.

In all the previous exemplary embodiments, the products may be services, or a combination of products and services.

The Innovative Solution—Enhanced Versions

The system for facilitating purchasing of items displayed in a streaming video, shown in FIG. 2 (or FIG. 1) is also used in the following exemplary embodiments, implementing enhanced versions of the innovative solution.

5^{th} Exemplary Implementation

In a 5^{th} exemplary implementation, the system of FIG. 2 (or FIG. 1) is used together with a mechanism to ensure that the video is automatically paused once the graphical or physical purchase button is pressed/selected, and resumed at the same time slot when the user completes the purchase or exits the purchase screen that is displayed upon selection of the purchase bottom.

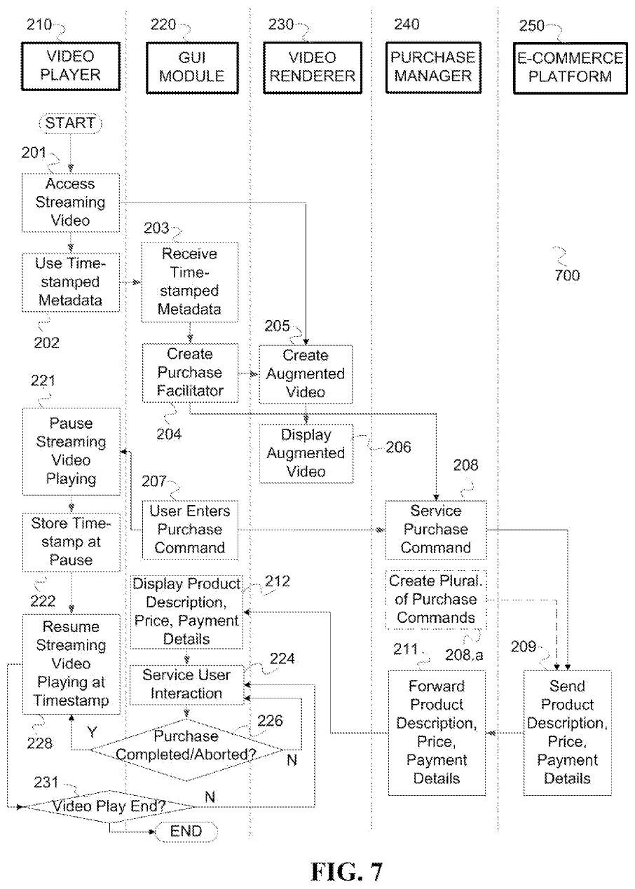

FIG. 7 shows a mid-level view of the main modules of present innovative solution, and their interactions for the 5^{th} exemplary implementation. View 700 shows the modules of Streaming Video Player 210, Graphical User Interface (GUI) 220, Video Renderer 230, Purchase Manager 240, and e-Commerce Platform 250. These modules may be implemented in hardware, software, firmware, or a combination thereof. In one aspect, modules 210-240 are implemented in streaming video player device 110, while in another aspect they are implemented in device 120 and/or 110.

E-commerce platform module 250 is implemented in e-commerce platform 140, which may reside in one or more e-commerce servers, or in the cloud. In alternative exemplary embodiments, the e-commerce platform 140 and module 250 are third-party e-commerce platforms (usually over the cloud) to which purchase manager 240 connects via connection/network 150.

Video player 210 accesses 201 a streaming video from a streaming server (not shown), and uses timestamped metadata 202 associated with specific time-segments of the streaming video content. Such metadata may, among other data, contain keywords or descriptions associated with a product shown in the video content and for which the present innovative solution implements and offers to the viewer a purchase facilitator for the viewer to buy the product, which product has appealed to the viewer and created an urge to buy it, without having to rely to an advertisement shown interlaced or embedded in the streaming video content.

Video player 210 sends the video content (which it has processed, e.g. for decompression, etc.) to video renderer 230, and the timestamped metadata to GUI 220. GUI 220 receives 203 the timestamped metadata, and creates 204 a purchase facilitator 204, which then sends to video renderer 230 and to purchase manager 240. In one aspect, the purchase facilitator is a barcode, a matrix code (e.g. a Quick Response (QR) code), or a sound code, while in other aspects it is a color code, watermark, video code, or sound code. In yet another aspect, the purchase facilitator is a graphical button (on device 110 and/or 120) associated with one of the previous codes and/or a web-address, and/or Internet Protocol (IP) address pointing to a location at e-commerce platform 140, associated with the product that appears in the content of the steaming video, a Universal Resource Locator (URL) pointing to an IP address. In another aspect, the purchase facilitator is a hardware button (e.g. a button on remote control 130, or a hardware button in device 120) associated with one of the previous codes and/or a web-address, and/or Internet Protocol (IP) address pointing to a location at e-commerce platform 140, associated with the product that appears in the content of the steaming video. In yet another aspect the purchase facilitator is a combination of the previous. GUI 220 sends the purchase facilitator to video renderer 230.

Video renderer 230 receives the video content from video player 210 and the purchase facilitator from GUI 220 and creates 205 and displays 206 an augmented video containing the video content embedded with the purchase facilitator. In one aspect, only the purchase facilitator is embedded on the video content, while in another aspect instructions and other optional information are also embedded.

In a variation of the 5^{th} exemplary implementation, system 100 also has a speaker 170 connected to the device playing the streaming video (i.e. device 110 or 120) for playing aloud the sound code and/or instruction and other optional information to the user for purchasing the product shown in the streaming video content, using the purchase facilitator. In the same exemplary implementation having speaker 170, system 100 also has a microphone 160 connected to the device used by the viewer for interacting with the video playing module (i.e. device 120, 130, or 170) via speech commands in addition or instead of interacting via any other known non-verbal interaction method (e.g. virtual or physical button press, gesture, etc.).

The viewer views the augmented video, during and immediately after the appearance of the product associated with the purchase facilitator in the video content and enters a verbal or non-verbal purchase command 207 using GUI 220. GUI 220 associates the purchase command with the purchase facilitator and sends the purchase command to purchase manager 240 and to video player 210 and the purchase facilitator to purchase manager 240.

In a variation of the 5^{th} exemplary implementation, purchase manager 240 creates, in step 208, a set of purchase commands 208.a equal to the number of products contained in the streaming video segment that the viewer has viewed since the current streaming video playing session was launched. Purchase manager sends the set of purchase commands to e-commerce platform 250, which replies with a set of product description, price and payment instructions. These are then rendered in the video content to create an augmented video with description, price and payment instructions for the products associated with the set of purchase commands. These may be presented to the user in a list (or other similar structure) format for him to choose.

Purchase manager 240 receives the purchase facilitator and the purchase command from GUI 220 and services 208 the purchase command using the purchase facilitator to which it is associated, by communicating with e-commerce platform 250.

E-commerce platform 250, upon receiving the purchase command, sends 209 a product description, price and payment instructions to purchase manager 240, which forwards 211 the product description, price and payment instructions as timestamped metadata to GUI 220 for displaying 212 to the viewer using the same mechanism previously described for creating and displaying the augmented video (steps 205, 206).

Upon reception of the purchase command from GUI module 220, video player 210 pauses the currently playing streaming video 221, stores the time-stamp 222 associated with the start time of the pause event, which is in turn associated with the video frame displayed during the start of the pause event.

During displaying of the product description, price, payment details, GUI 220 services user interaction 224 (which interaction is effected with remote control 130, voice commands, or touch interaction). Upon completion of the purchase of a product, or after the user aborts the purchase of the product, GUI module 220 signals video player 210 the purchase completed/aborted 226, which causes video player 210 to resume the streaming video playing 228 using the stored time stamp at pause 222 as a pointer to the paused time and video frame, so that the viewer can watch the rest of the video without losing any part of it. The methodology ends with the end of the streaming video 231, either by playing the last video frame of the streaming video, or upon reception at video player 210, via GUI module 220, of a stop command entered by the viewer.

6^{th} Exemplary Implementation

In a 6^{th} exemplary implementation, the system of FIG. 2 is used together with a mechanism to ensure that the video is automatically paused once the graphical or physical purchase button (i.e the purchase facilitator) is pressed/selected, and resumed at the same time slot when the user completes the purchase or exits the purchase screen that is displayed upon selection of the purchase bottom.

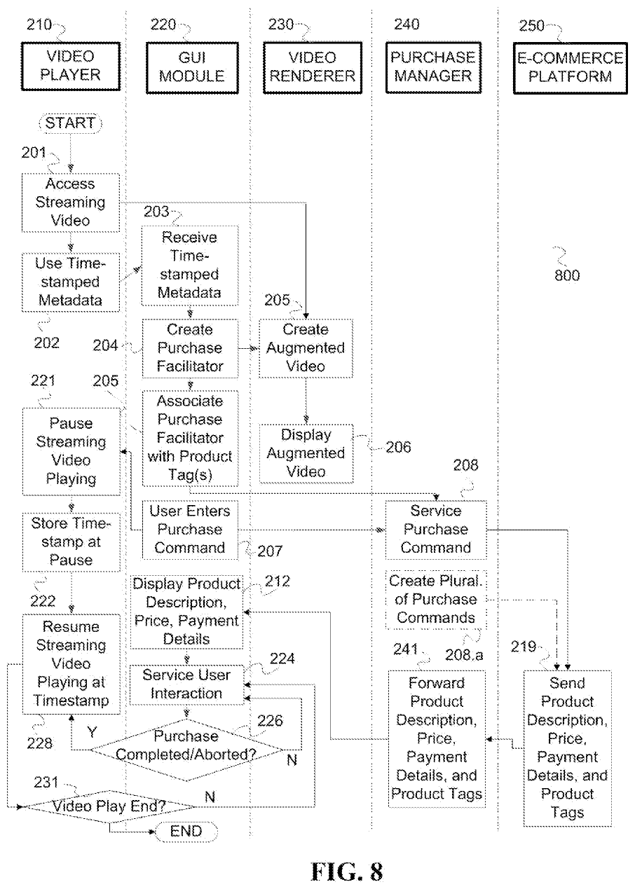

FIG. 8 shows a mid-level view of the main modules of present innovative solution, and their interactions for the 6^{th} exemplary implementation. View 800 shows the modules of Streaming Video Player 210, Graphical User Interface (GUI) 220, Video Renderer 230, Purchase Manager 240, and e-Commerce Platform 250. These modules may be implemented in hardware, software, firmware, or a combination thereof. In one aspect, modules 210-240 are implemented in streaming video player device 110, while in another aspect they are implemented in device 120 and/or 110.

E-commerce platform module 250 is implemented in e-commerce platform 140, which may reside in one or more e-commerce servers, or in the cloud. In alternative exemplary embodiments, the e-commerce platform 140 and module 250 are third-party e-commerce platforms (usually over the cloud) to which purchase manager 240 connects via connection/network 150.

Video player 210 accesses 201 a streaming video from a streaming server (not shown), and uses timestamped metadata 202 associated with specific time-segments of the streaming video content. Such metadata may, among other data, contain keywords or descriptions associated with a product shown in the video content and for which the present innovative solution implements and offers the viewer a purchase facilitator for the viewer to buy the product, which product has appealed to the viewer and created an urge to buy it, without having to rely to an advertisement shown interlaced or embedded in the streaming video content.

Video player 210 sends the video content (which it has processed, e.g. for decompression, etc.) to video renderer 230, and the timestamped metadata to GUI 220. GUI 220 receives 203 the timestamped metadata, and creates 204 a purchase facilitator 204. In one aspect, the purchase facilitator is a barcode, a matrix code (e.g. a Quick Response (QR) code), or a sound code, while in other aspects it is a color code, watermark, video code, or sound code. In yet another aspect, the purchase facilitator is a graphical button (on device 110 and/or 120) associated with one of the previous codes and/or a web-address, and/or Internet Protocol (IP) address pointing to a location at e-commerce platform 140, associated with the product that appears in the content of the steaming video, a Universal Resource Locator (URL) pointing to an IP address. In another aspect, the purchase facilitator is a hardware button (e.g. a button on remote control 130, or a hardware button in device 120) associated with one of the previous codes and/or a web-address, and/or Internet Protocol (IP) address pointing to a location at e-commerce platform 140, associated with the product that appears in the content of the steaming video. In yet another aspect the purchase facilitator is a combination of the previous. GUI 220 sends the purchase facilitator to video renderer 230.

GUI module 220 module associates purchase facilitator 204 with one or more product tags, associated with one or more products. These product tags may be a code number, a barcode, a number represented by a barcode, a QR (or other code), an alphanumeric string represented by a QR or other code, etc. GUI module 220 then sends purchase facilitator 204 to video renderer 230 and to purchase manager 240.

Video renderer 230 receives the video content from video player 210 and the purchase facilitator from GUI 220 and creates 205 and displays 206 an augmented video containing the video content embedded with the purchase facilitator. In one aspect, only the purchase facilitator is embedded on the video content, while in another aspect instructions and other optional information are also embedded.

In a variation of the 6^{th} exemplary implementation, system 100 also has a speaker 170 connected to the device playing the streaming video (i.e. device 110 or 120) for playing aloud the sound code and/or instruction and other optional information to the user for purchasing the product shown in the streaming video content, using the purchase facilitator. In the same exemplary implementation having speaker 170, system 100 also has a microphone 160 connected to the device used by the viewer for interacting with the video playing module (i.e. device 120, 130, or 170) via speech commands in addition or instead of interacting via any other known non-verbal interaction method (e.g. virtual or physical button press, gesture, etc.).

The viewer views the augmented video, during and immediately after the appearance of the product associated with the purchase facilitator in the video content and enters a verbal or non-verbal purchase command 207 using GUI 220. GUI 220 associates the purchase command with the purchase facilitator and sends the purchase command to purchase manager 240 and to video player 210 and the purchase facilitator to purchase manager 240.

Purchase manager 240 receives the purchase facilitator and the purchase command from GUI 220 and services 208 the purchase command using the purchase facilitator to which it is associated, by communicating with e-commerce platform 250.

In a variation of the 6^{th} exemplary implementation, purchase manager 240 creates, in step 208, a set of purchase commands 208.a equal to the number of products contained in the streaming video segment that the viewer has viewed since the current streaming video playing session was launched. Purchase manager sends the set of purchase commands to e-commerce platform 250, which replies with a set of product description, price and payment instructions. These are then rendered in the video content to create an augmented video with description, price and payment instructions for the products associated with the set of purchase commands. These may be presented to the user in a list (or other similar structure) format for him to choose.

E-commerce platform 250, upon receiving the purchase command, sends 219 a product description, price, payment instructions, and product tags to purchase manager 240, which forwards 241 the product description, price payment instructions, and product tags as timestamped metadata to GUI 220 for displaying 212 to the viewer using the same mechanism previously described for creating and displaying the augmented video (steps 205, 206).

Upon reception of the purchase command from GUI module 220, video player 210 pauses the currently playing streaming video 221, stores the time-stamp 222 associated with the start time of the pause event, which is in turn associated with the video frame displayed during the start of the pause event.

During displaying of the product description, price, payment details, GUI 220 services user interaction 224 (which interaction is effected with remote control 130, voice commands, or touch interaction).

User interaction is serviced 224 by GUI module 220 using the product tags 205 that are associated with purchase facilitator 204. In particular, product tags are used to facilitate navigation in the database storing the products of e-commerce platform 250. As the database of e-commerce platform 250 stores, typically, a large selection of product and not only the products associated with the streaming video and the purchase command, the use of product tags allows e-commerce platform 250 not only to select and send Product Description, Price, and Payment Details for the product associated in the purchase command but also to select and send data related to additional products related to the product associated in the purchase command. For example, e-commerce platform 250 may use product tags to select products identical to the product associated in the purchase command but of different size, color, etc., similar and/or complementary products of the same brand, etc. Furthermore, e-commerce platform 250 may use product tags to create promotions for groups of products, special prices and advertisements, stories featuring additional related products, etc. in an effort to secure a purchase and at the same time maximize purchase volumes, and create repeat purchases, etc.

Upon completion of the purchase of a product, or after the user aborts the purchase of the product, GUI module 220 signals video player 210 the purchase completed/aborted 226, which causes video player 210 to resume the streaming video playing 228 using the stored time stamp at pause 222 as a pointer to the pause time and video frame, so that the viewer can watch the rest of the video without losing any part of it. The methodology ends with the end of the streaming video 231, either by playing the last video frame of the streaming video, or upon reception at video player 210, via GUI module 220, of a stop command entered by the viewer.

In a variation of the 6^{th} exemplary implementation, the methodology of FIG. 8 is adapted to the steps of the methodology of the 1^{st} exemplary implementation.

7^{th} Exemplary Implementation

In a 7^{th} exemplary implementation, a mechanism is used for relating the terms of purchase, discounts, etc. to the duration of the streaming video, once a user of the innovative solution has entered the e-shop implemented by e-commerce platform 250. For example, time-stamps are used and a flag is set for the duration of the streaming video (e.g. when a live football game is viewed) and the viewer selects to purchase a product shown in the video, he presses the button and the video is automatically paused until he completes the purchase or exits the purchase screen. At the same time, the live game is still being played. This data is linked to e-commerce platform 250, which sets a discount price valid only until the end of the real game or until the end of the current part of the real game (e.g. the first half). This way, an urge to buy the product is created for not losing a discount (or other incentive), effectively increasing the conversion rate and securing a sale which could have otherwise been lost if the viewer had lost interest, etc.

8^{th} Exemplary Implementation

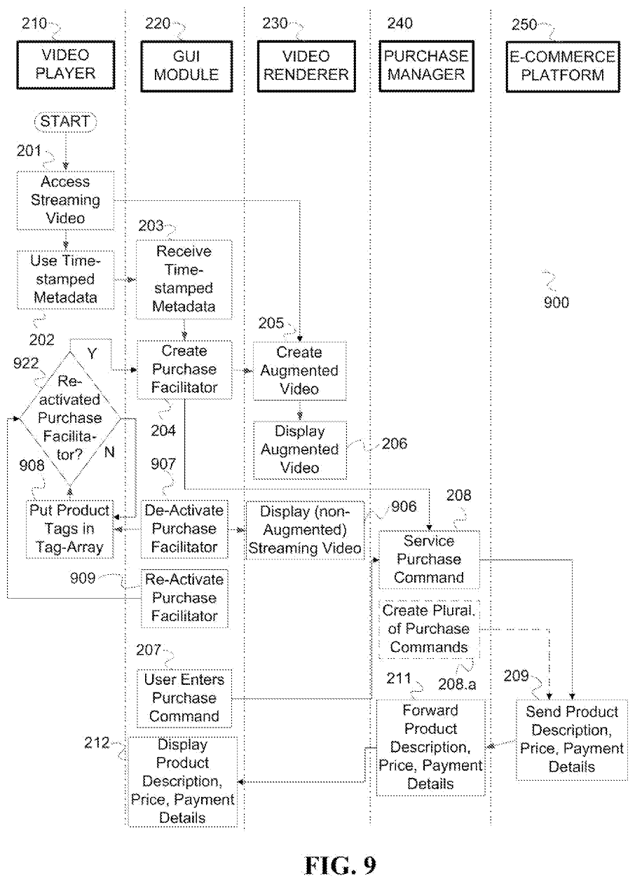

FIG. 9 shows a mid-level view of the main modules of present innovative solution, and their interactions for the 8^{th} exemplary implementation. View 900 shows the modules of Streaming Video Player 210, Graphical User Interface (GUI) 220, Video Renderer 230, Purchase Manager 240, and e-Commerce Platform 250. These modules may be implemented in hardware, software, firmware, or a combination thereof. In one aspect, modules 210-240 are implemented in streaming video player device 110, while in another aspect they are implemented in device 120 and/or 110.

E-commerce platform module 250 is implemented in e-commerce platform 140, which may reside in one or more e-commerce servers, or in the cloud. In alternative exemplary embodiments, the e-commerce platform 140 and module 250 are third-party e-commerce platforms (usually over the cloud) to which purchase manager 240 connects via connection/network 150.

Video player 210 accesses 201 a streaming video from a streaming server (not shown), and uses timestamped metadata 202 associated with specific time-segments of the streaming video content. Such metadata may, among other data, contain keywords or descriptions associated with a product shown in the video content and for which the present innovative solution implements and offers to the viewer a purchase facilitator for the viewer to buy the product, which product has appealed to the viewer and created an urge to buy it, without having to rely to an advertisement shown interlaced or embedded in the streaming video content.

Video player 210 sends the video content (which it has processed, e.g. for decompression, etc.) to video renderer 230, and the timestamped metadata to GUI 220. GUI 220 receives 203 the timestamped metadata, and creates 204 a purchase facilitator 204, which then sends to video renderer 230 and to purchase manager 240. In one aspect, the purchase facilitator is a barcode, a matrix code (e.g. a Quick Response (QR) code), or a sound code, while in other aspects it is a color code, watermark, video code, or sound code. In yet another aspect, the purchase facilitator is a graphical button (on device 110 and/or 120) associated with one of the previous codes and/or a web-address, and/or Internet Protocol (IP) address pointing to a location at e-commerce platform 140, associated with the product that appears in the content of the steaming video, a Universal Resource Locator (URL) pointing to an IP address. In another aspect, the purchase facilitator is a hardware button (e.g. a button on remote control 130, or a hardware button in device 120) associated with one of the previous codes and/or a web-address, and/or Internet Protocol (IP) address pointing to a location at e-commerce platform 140, associated with the product that appears in the content of the steaming video. In yet another aspect the purchase facilitator is a combination of the previous. GUI 220 sends the purchase facilitator to video renderer 230.

Video renderer 230 receives the video content from video player 210 and the purchase facilitator from GUI 220 and creates 205 and displays 206 an augmented video containing the video content embedded with the purchase facilitator. In one aspect, only the purchase facilitator is embedded on the video content, while in another aspect instructions and other optional information are also embedded.

In a variation of the 8^{th} exemplary implementation, system 100 also has a speaker 170 connected to the device playing the streaming video (i.e. device 110 or 120) for playing aloud the sound code and/or instruction and other optional information to the user for purchasing the product shown in the streaming video content, using the purchase facilitator. In the same exemplary implementation having speaker 170, system 100 also has a microphone 160 connected to the device used by the viewer for interacting with the video playing module (i.e. device 120, 130, or 170) via speech commands in addition or instead of interacting via any other known non-verbal interaction method (e.g. virtual or physical button press, gesture, etc.).

The user instructs GUI module 220 to deactivate the purchase facilitator 907 (e.g. by using his remote control or by a voice command), and GUI module 220 forwards the deactivate command to video renderer 230 for stopping displaying the augmented video and starting displaying the original streaming video without the purchase facilitator 906. GUI module 220 also sends the deactivate command to video player 210. Video player 210 puts in a Tag Array 908 all product tags associated with the products currently screened in the streaming video (and optionally also the tags associated with the products previously screened in the streaming video). These product tags may be a code number, a barcode, a number represented by a barcode, a QR (or other code), an alphanumeric string represented by a QR or other code, etc.

Since no purchase facilitator is displayed after the viewer entered the purchase facilitator deactivation command 907, the viewer may see the products displayed in the (non-augmented) streaming video but his attention is not drawn to these products as no purchase facilitator is displayed.

At any point in time, the viewer may re-activate the purchase facilitator 909 by entering a purchase facilitator reactivate command to GUI module 220, using his remote control or verbally. GUI module 220 forward the purchase facilitator reactivate command to video player 210, and video player 210 then forwards the product tags, stored in the Tag-Array, to GUI module 220.

GUI module 220, has already received the purchase facilitator reactivate command, and upon reception 922 of the product tags from video player 210, creates purchase facilitator 204 (in one aspect a purchase button), which is linked to the current (and optionally the previous) content of the streaming video, i.e to the product tags received from video player 210. The mechanism will ensure that the purchase facilitator (e.g. a purchase button) will, upon activation, present a list of products that currently or previously appeared in the video without missing any products that were screened while the purchase facilitator was deactivated.

Video renderer 230 receives the video content from video player 210 and the purchase facilitator from GUI 220 and creates 205 and displays 206 an augmented video containing the video content embedded with the purchase facilitator. In one aspect, only the purchase facilitator is embedded on the video content, while in another aspect instructions and other optional information are also embedded.

The viewer views the augmented video, during and after the appearance of the product associated with the purchase facilitator in the video content and enters a verbal or non-verbal purchase command 207 using GUI 220. GUI 220 associates the purchase command with the purchase facilitator and sends the purchase command to purchase manager 240.

Purchase manager 240 receives the purchase facilitator and the purchase command from GUI 220 and services 208 the purchase command using the purchase facilitator to which it is associated, by communicating with e-commerce platform 250.

In a variation of the 8^{th} exemplary implementation, purchase manager 240 creates, in step 208, a set of purchase commands 208.a equal to the number of products contained in the streaming video segment that the viewer has viewed since the current streaming video playing session was launched. Purchase manager sends the set of purchase commands to e-commerce platform 250, which replies with a set of product description, price and payment instructions. These are then rendered in the video content to create an augmented video with description, price and payment instructions for the products associated with the set of purchase commands. These may be presented to the user in a list (or other similar structure) format for him to choose.

E-commerce platform 250, upon receiving the purchase command, sends 209 a product description, price and payment instructions to purchase manager 240, which forwards 211 the product description, price and payment instructions as timestamped metadata to GUI 220 for displaying 212 to the viewer using the same mechanism previously described for creating and displaying the augmented video (steps 205, 206).

The 8^{th} exemplary embodiment may also be modified to include the additional functionalities of the 6^{th} exemplary embodiment, which are associated with pausing the playing of the streaming video.

9^{th} Exemplary Implementation

In an 9^{th} exemplary implementation, the viewer may use either the same device used for viewing the streaming video (e.g. any type of television or computing device possessing a screen capable of displaying video), or a separate device (e.g. a remote control device, a smartphone, a tablet, a smartwatch, a haptic interaction device, a gesture interaction device, a camera with image analysis software, etc.) for interacting with the present innovative system. Using any of these devices, the viewer may control the playback of the streaming video, activate or de-activate the purchase facilitator, browse products, promotions, and commercials in the e-commerce platform, and select and purchase products. The product facilitator may be implemented in any way and may include combinations of different implementations, like graphical buttons, QR or other codes, etc.

10^{th} Exemplary Implementation

In a 10^{th} exemplary embodiment, the present innovative solution is used not only on streaming video but on any kind of video. This may include TV programs broadcasted on live TV, video-on-demand, video stored on any storage medium (e.g. hard disk, flash disk or memory, DVD, CD, etc.). The present innovative solution relies on the use of metadata embedded on the video content. For video accessed from a data network or from a data storage device, the metadata form part of the content of a video file and may be formatted according to any current or future standards, without limiting the scope of protection of the present innovative solution. In the case of broadcasted TV programs, the metadata needed by the present innovative solution to operate may be embedded in any metadata system used by the broadcaster. In one aspect, the metadata may be embedded in a “teletext” signal, or in control signals that are broadcasted with the video content (e.g. TV program information signals).

In another aspect, the purchase facilitator is permanently displayed on the screen while in other aspects the purchase facilitator is selectively displayed on the screen by the system, only when a product appears in the content of the video scene.

In another aspect, most (if not all known) TV or video programs are broadcasted as streaming video and so, the present innovative solution relies on metadata (or tags) embedded in the streaming video.

Example Streaming Video Use Cases for the Enhanced Versions of the Innovative Solution

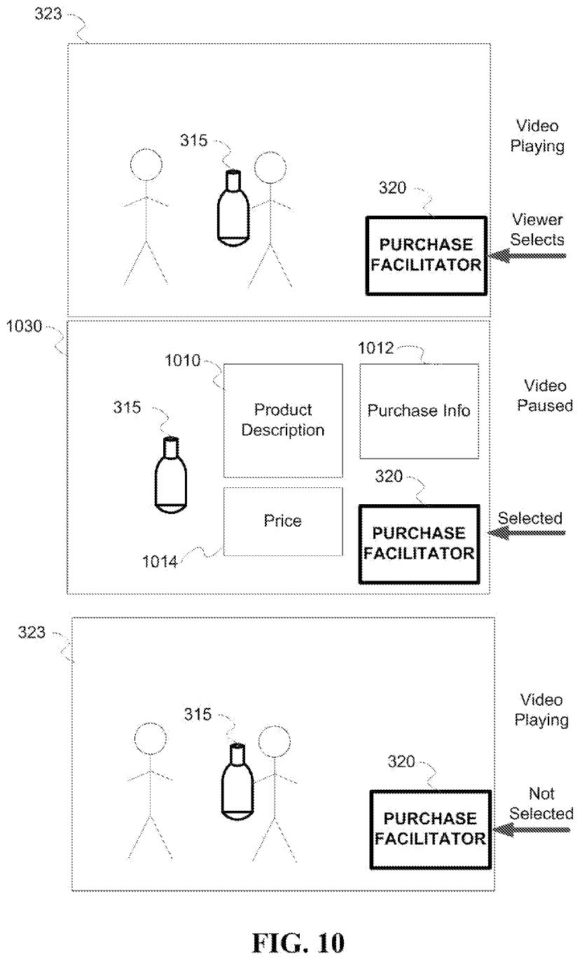

FIG. 10 shows an example streaming video with a purchase facilitator according to the 5^{th} exemplary embodiment of the present innovative solution. Streaming Video 323 contains a scene where two persons are shown in front of a table which contains a bottle of whiskey 315. Video renderer 230 renders the content of the streaming video scene with a purchase facilitator 320, which is related to the bottle of whiskey 315 in the scene, and which purchase facilitator 320 facilitates the viewer to easily and quickly make his purchase according to the methodology presented in FIG. 7. Purchase facilitator 320 is not intended for attracting the viewer's attention to the product; attracting the viewer's attention is achieved by the product itself, i.e. the whiskey bottle that appears in the streaming video scene, and potentially also by the dialogues and the plot in the scene of the streaming video. Purchase facilitator 320 is merely a way to facilitate purchase of the product in the scene of the streaming video. The viewer selects purchase facilitator 320. In response, the system pauses the playing video 323 and displays screen 1030, which contains the selected purchase facilitator 320, product 315 (i.e. the whisky bottle), a product description 1010, product price 1014, purchase information 1012. Screen 1030 may also contain additional information not shown in FIG. 10. Upon terminating or aborting his purchase, the viewer is presented with video 323, which is now resumed and purchase facilitator is not selected anymore.

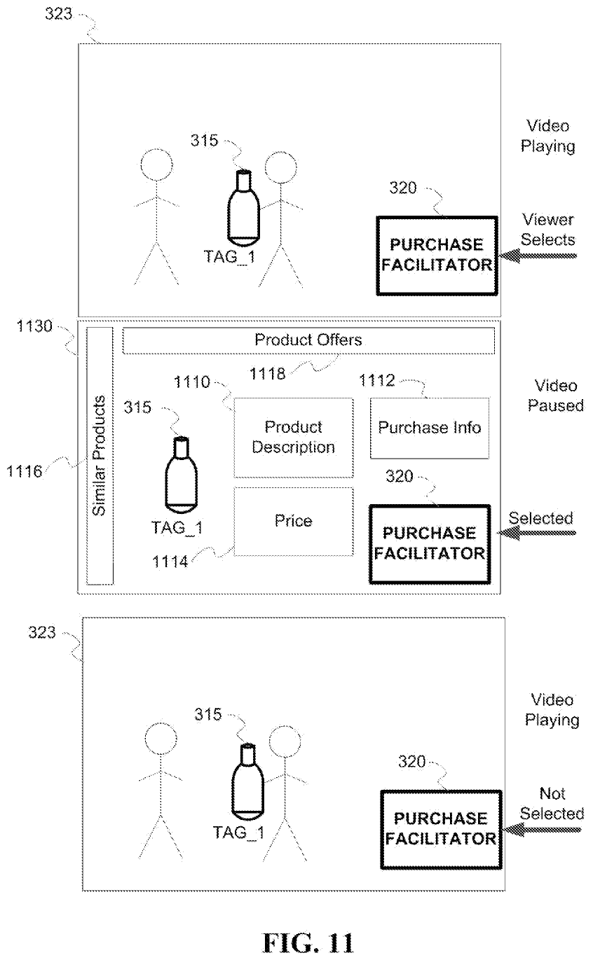

FIG. 11 shows an example streaming video with a purchase facilitator according to the 6^{th} exemplary embodiment of the present innovative solution. Streaming Video 323 contains a scene where two persons are shown in front of a table which contains a bottle of whiskey 315. Video renderer 230 renders the content of the streaming video scene with a menu (or list or a similar structure) of purchase facilitators 330, which is related to the bottle of whiskey 315 in the scene, and which menu of purchase facilitators 330 facilitates the viewer to easily and quickly make his purchase according to the methodology presented in FIG. 8. Product 315 is associated with TAG_1 (the tag is not displayed to the viewer).

The viewer selects purchase facilitator 320. In response, the system pauses the playing video 323 and connects to e-commerce platform 250 for displaying screen 1130 which contains the selected purchase facilitator 320, product 315 (i.e. the whisky bottle), a product description 1110, product price 1114, purchase information 1112, and additional information such as similar products 1116, product offers 1118, etc. Screen 1130 may also contain additional information not shown in FIG. 10. The selection of the products to display in the similar products 1116 area and the offers in the product offers 1118 area is done by e-commerce platform 250 using the TAG_1 associated with product 315. E-commerce platform 250 matches TAG_1 with the tags of other products stored in a database (or other storage structure) storing the products sold by e-commerce platform 250.

Upon terminating or aborting his purchase, the viewer is presented with video 323, which is now resumed and purchase facilitator is not selected anymore.

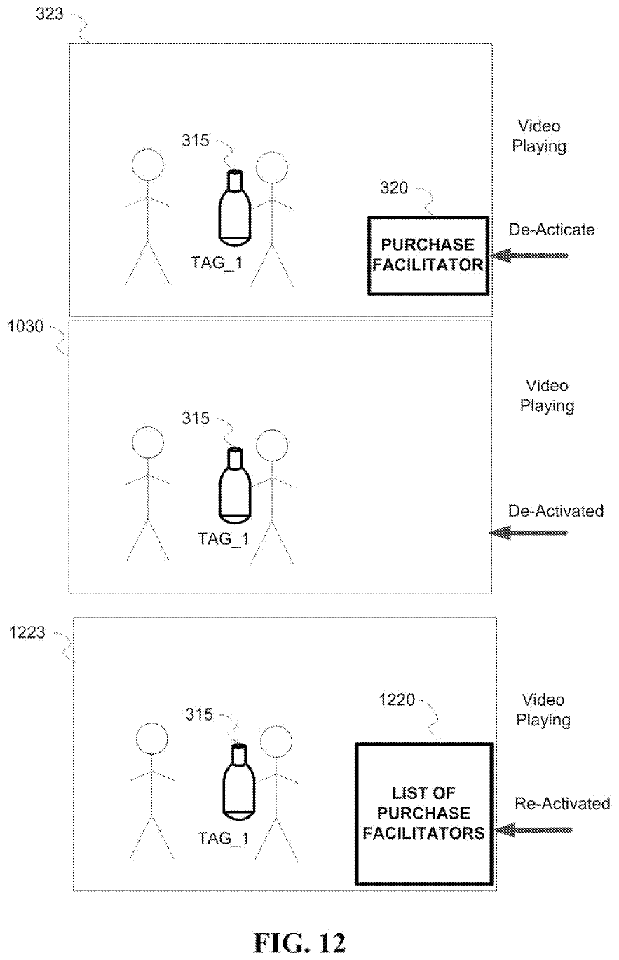

FIG. 12 shows an example streaming video with a purchase facilitator according to the 8^{th} exemplary embodiment of the present innovative solution. Streaming Video 323 contains a scene where two persons are shown in front of a table which contains a bottle of whiskey 315. Video renderer 230 renders the content of the streaming video scene with a menu (or list or a similar structure) of purchase facilitators 330, which is related to the bottle of whiskey 315 in the scene, and which menu of purchase facilitators 330 facilitates the viewer to easily and quickly make his purchase according to the methodology presented in FIG. 8. Product 315 is associated with TAG_1 (the tag is not displayed).

The viewer deactivates purchase facilitator 320. In response, the system removes purchase facilitator 320 from the playing video 323. The viewer continues watching the streaming video.

The viewer re-activates purchase facilitator 320. In response, the system renders purchase facilitator 1220 onto the playing video 323 to create an augmented video 1223.

Purchase facilitator 1220 is associated to the current (and optionally the previous) content of the streaming video. Once the viewer selects purchase facilitator 1220, the system renders a new screen, which presents a list of products that currently or previously appeared in the video without missing any products that were screened while the button was deactivated. This new screen may have the form of screen 1130 in FIG. 11, or may take any other form which allows the displaying of multiple products, and which screen the viewer can navigate. Control of the navigation is done by the system using the tags associated with the various products. These tags were put in the Tag-Array 908, as described in the methodology of FIG. 9.

Upon terminating or aborting his purchase, the viewer is presented with video 323, which is now resumed and purchase facilitator 1220 is not selected anymore.

In all the previous exemplary embodiments, the products may be services, or a combination of products and services.

It is assumed that a person of ordinary skill in related art can appreciate that various modifications and/or combinations of the exemplary implementations of the present innovative solution fall within the intended scope of protection, as they are obvious over the described exemplary implementations, even if these modifications and/or combinations are not exhaustively described. Similarly, the layout of the exemplary screens and their indicative content may be modified without limiting the scope of protection.

All the exemplary implementations may work on any type of video content. By means of example this may be sports, movies, news, commercials, etc.

It is noted that the modules of FIG. 2-3 may be implemented physically or virtually, using off-the-shelf or purpose-built hardware, software, firmware or a combination thereof without departing from or limiting the scope of protection of the present innovative solution. As such the present innovative solution can be implemented as a system, a device, an apparatus, software or firmware running on one or more system, device, or apparatus, or a computer implemented method.

The software and hardware components shown in FIG. 2-3 are presented by means of example and other components may be present but not shown in these Figures, or some of the displayed components may be omitted. Other hardware and software may be possibly selected among known architectures. Especially the computing and interaction apparatuses may be implemented as dedicated physical or as virtual computing apparatuses.

The software running at any of the computing apparatuses may be implemented in any computing language, or in an abstract language (e.g. a metadata-based description which is then interpreted by a software or hardware component). The software running in the above-mentioned hardware, effectively transforms a general-purpose or special-purpose hardware, or computing device, or system into one that specifically implements the present innovative solution.

In the above exemplary embodiments, any computing apparatus and any interaction means, apparatus, or module may be used.

The above exemplary embodiments are intended for use either as a standalone solution or as part of other methods, processes and systems.

The above exemplary embodiment descriptions are simplified and do not include hardware and/or software elements that are used in the embodiments but are not part of the current solution, are not needed for the understanding of the embodiments, and are obvious to any user of ordinary skill in related art. Furthermore, variations of the described method, system architecture, and software architecture are possible, where, for instance, method steps, and hardware and software elements may be rearranged, omitted, or new added.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiments were chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or any other device or apparatus operating as a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for facilitating purchasing products displayed in a video, comprising:
a video player configured for accessing a video and using timestamped metadata associated with a content of the video;
a Graphical User Interface (GUI) module configured for receiving the timestamped metadata from the video player and creating a purchase facilitator associated with a product displayed in the video and with the timestamped metadata;
a video renderer configured for receiving the video from the video player, receiving the purchase facilitator from the GUI module, creating an augmented video by rendering the video with the purchase facilitator, and displaying the augmented video;
a purchase manager configured for receiving the purchase facilitator, receiving a purchase command from the GUI module in response to a user entering the purchase command, and servicing the purchase command using the purchase facilitator, wherein the purchase command is associated with the purchase facilitator; and
an e-commerce platform configured for receiving the purchase command from the purchase manager and sending to the purchase manager a description, a price, and payment instructions for the product associated with the purchase command, wherein the purchase manager is further configured for sending the description, price, and payment instructions to the GUI module as timestamped metadata;
wherein the GUI module is further configured for receiving the purchase command from the user and forwarding the purchase command to the video player, and the video player is further configured for pausing the video upon reception of the purchase command and resuming the video playing upon one of completion and aborting a purchase associated with the purchase command

2. The system of claim 1, wherein the purchase manager is further configured for servicing the purchase command by creating a plurality of purchase commands each associated with a product, associated with timestamped metadata and with a plurality of past products in the content of the video.

3. The system of claim 1 wherein one of the at least one product is a service.

4. The system of claim 1, wherein the purchase facilitator is selected among a graphical button, a menu, a barcode, a matrix code, a sound code, a color code, a watermark, a video code, a Universal Resource Locator (URL), a hardware button, and a combination thereof.

5. The system of claim 1, wherein the product is associated with a first product tag, and the e-commerce platform is further configured to allow navigation using the first product tag and to create at least one marketing campaign and at least one product discount by matching the first product tag with at least another product tag stored at the e-commerce platform, wherein the at least another product tag is associated with at least another product.

6. The system of claim 5, wherein the at least one marketing campaign and the at least one discount are valid until the end of a live video content associated with the paused video.

7. The system of claim 1, wherein:
the GUI module is further configured for de-activating the purchase facilitator and sending a purchase facilitator de-activation command to the video renderer and to the video player;
the video renderer is configured for displaying non-augmented video upon reception of the purchase facilitator de-activation command; and
the video player is configured for putting at least another product tag into a tag array, wherein each of the at least another product tag is associated with at least another product contained in the video content after the purchase facilitator has been deactivated, and sending the at least another product tag from the tag array to the GUI module for recreating the purchase facilitator upon reception of a purchase facilitator reactivate command from the GUI module, wherein the recreated purchase facilitator is associated with the at least another product.

8. The system of claim 1, wherein the wherein each of the at least another product tag is also associated with at least another product contained in the video content before the purchase facilitator has been deactivated.

9. The system of claim 1, wherein the GUI module is associate with an interaction device selected among the device used for screening the video, a remote control, a smartphone, a tablet, a smartwatch, a haptic interaction device, a gesture interaction device, and a camera with image analysis software.

10. The system of claim 1, wherein the video is selected among a streaming video, a television broadcasting, a movie, a sports event, and a commercial.

11. A method of facilitating purchasing products displayed in a video, the method comprising:
accessing with a video player a video and using timestamped metadata associated with a content of the video;
receiving at a Graphical User Interface (GUI) module the timestamped metadata from the video player;
creating a purchase facilitator associated with a product displayed in the video and with the timestamped metadata;
receiving at a video renderer the video from the video player and the purchase facilitator from the GUI module, creating an augmented video by rendering the video with the purchase facilitator, and displaying the augmented video;
receiving at the GUI module a purchase command from a viewer, and forwarding the purchase command to the video player;
pausing the video, using the video player, upon reception of the purchase command, and resuming the video playing upon one of completion and aborting a purchase associated with the purchase command;
receiving at a purchase manager the purchase facilitator, the purchase command from the GUI module in response to a viewer entering the purchase command, and servicing the purchase command using the purchase facilitator, wherein the purchase command is associated with the purchase facilitator;
receiving at an e-commerce platform the purchase command from the purchase manager, and sending to the purchase manager a description, a price, and payment instructions for the product associated with the purchase command; and
sending the description, price, and payment instructions from the purchase manager to the GUI module as timestamped metadata.

12. The method of claim 11, further comprising:
servicing the purchase command with the purchase manager by creating a plurality of purchase commands each associated with a product, timestamped metadata and a plurality of past products in the content of the video.

13. The method of claim 11, wherein one of the at least one product is a service.

14. The method of claim 11, wherein the purchase facilitator is selected among a graphical button, a menu, a barcode, a matrix code, a sound code, a color code, a watermark, a video code, a Universal Resource Locator (URL), a hardware button, and a combination thereof.

15. The method of claim 11, further comprising:
associating the product with a first product tag;
allowing navigation in the e-commerce platform using the first product tag;
creating at least one marketing campaign and at least one product discount by matching the first product tag with at least another product tag stored at the e-commerce platform, wherein the at least another product tag is associated with at least another product.

16. The method of claim 11, wherein the at least one marketing campaign and the at least one discount are valid until the end of a live video content associated with the paused video.

17. The method of claim 11, further comprising:
de-activating the purchase facilitator at the GUI module and sending a purchase facilitator de-activation command from the GUI module to the video renderer and to the video player;
displaying non-augmented video using the video renderer upon reception of the purchase facilitator de-activation command;
putting at least another product tag into a tag array using the video player, wherein each of the at least another product tag is associated with at least another product contained in the video content after the purchase facilitator has been deactivated; and
sending the at least another product tag from the tag array to the GUI module for recreating the purchase facilitator upon reception of a purchase facilitator reactivate command from the GUI module, wherein the recreated purchase facilitator is associated with the at least another product.

18. The method of claim 11, wherein the GUI module is associate with an interaction device selected among the device used for screening the video, a remote control, a smartphone, a tablet, a smartwatch, a haptic interaction device, a gesture interaction device, and a camera with image analysis software.

19. The method of claim 11, wherein the video is selected among a streaming video, a television broadcasting, a movie, a sports event, and a commercial.

20. A non-transitory computer program product for facilitating purchasing products displayed in a video, the non-transitory computer program product comprising instructions to cause a computer to:
access with a video player a video and using timestamped metadata associated with a content of the video;
receive at a Graphical User Interface (GUI) module the timestamped metadata from the video player;
create a purchase facilitator associated with a product displayed in the video and with the timestamped metadata;
receive at a video renderer the video from the video player and the purchase facilitator from the GUI module, creating an augmented video by rendering the video with the purchase facilitator, and displaying the augmented video;
receive at the GUI module a purchase command from a viewer, and forwarding the purchase command to the video player;
pause the video, using the video player, upon reception of the purchase command, and resuming the video playing upon one of completion and aborting a purchase associated with the purchase command;
receive at a purchase manager the purchase facilitator, the purchase command from the GUI module in response to a viewer entering the purchase command, and servicing the purchase command using the purchase facilitator, wherein the purchase command is associated with the purchase facilitator;
receive at an e-commerce platform the purchase command from the purchase manager, and sending to the purchase manager a description, a price, and payment instructions for the product associated with the purchase command; and
send the description, price, and payment instructions from the purchase manager to the GUI module as timestamped metadata.
